(19) United States
(12) Patent Application Publication
(10) Pub. No.: US 2010/0206832 A1
(43) Pub. Date: Aug. 19, 2010

(54) DELIVERY TOWER CRANE JIB WITH FURLING DEVICE

(75) Inventor: JEAN-CLAUDE GATEAU, Saint Symphorien Des Bois (FR)

Correspondence Address: CANTOR COLBURN, LLP, 20 Church Street, 22nd Floor, Hartford, CT, 06103, US

(73) Assignee: MANITOWOC CRANE GROUP FRANCE, ECULLY (FR)

(21) Appl. No.: 12/695,703

(22) Filed: Jan. 28, 2010

(30) Foreign Application Priority Data
Jan. 29, 2009 (FR) 09/50550

(51) Int. Cl. B66C 23/68

(52) U.S. Cl. 212/347

(57) ABSTRACT

The jib is made up of at least two jib elements connected by a pivot pin, the furling device includes an actuating cylinder one end of which is permanently articulated to the first jib element and, secured to the second jib element, a set of attachment points laid out on one and the same circle centred on the pin, the other end of the actuating cylinder is selectively and detachably connected to one of the attachment points so that the jib can be furled or unfurled through a succession of rotations corresponding to the angular spacing between two consecutive attachment points, where means temporarily immobilize one jib element with respect to the other in intermediate furling positions when the actuating cylinder has been detached from one attachment point in order to be attached to the next one.

### TECHNICAL FIELD

The present invention relates in general to the technical field of delivery tower cranes, that is to say of cranes that have a jib, generally a horizontal one, along which there travels a crab under which the load that is to be lifted or moved is suspended. More specifically, this invention relates to the jib of such a crane and, more specifically still, to a jib made up of two or more jib elements with at least two successive jib elements joined together by a horizontal pivot pin, with which there is associated a furling device driven by at least one actuating cylinder, particularly a hydraulic actuating cylinder.

### BACKGROUND

A delivery tower crane is made up of two main parts, these being: firstly, a vertical mast or tower, and secondly, positioned at the top of the mast or tower, a jib, generally horizontal, along which there travels a jib crab under which the load that is to be lifted or moved is suspended. Beyond the top of the mast, the jib may be extended by a counterjib supporting a counterweight.

The mast or tower of such cranes is generally made up of superposed mast elements. These cranes attain their working position at the desired height by the addition of additional mast elements, using a telescoping device. When the construction of a building or other structure is complete, the crane is dismantled, first mast element by mast element, until the jib and counterjib are brought practically down to ground level whereupon the jib and counterjib can then also be dismantled. This therefore assumes that the jib can be lowered down to ground level without encountering any obstacle as the mast elements are progressively removed.

However, in certain circumstances and particularly when building cooling towers for thermal or nuclear electricity power stations, it is impossible to dismantle the crane in this way because the building or the structure that has been built impedes the downward progress of the jib. In particular, in the case of the construction of a cooling tower, the mast of the crane stands along the vertical central axis of the tower, which means that the jib would “butt” against the top of this tower if any attempt were made simply at lowering it.

In order to solve this problem of dismantling under exceptional circumstances, use has hitherto been made of a special jib crab which allows one or more elements of the jib to be dismantled in order to reduce the length of the jib before this jib is lowered down to ground level. Such an operation of partial dismantling of the jib is lengthy, complex and dangerous, because human intervention high up is required here in order to dismantle one or more elements of the jib.

It is also possible, in order to solve this problem, to conceive of creating jibs that can be furled using a mechanism involving an actuating cylinder, as illustrated, for example, in patent documents FR 2682097 (or its equivalent EP 0536060) and FR 2732000 (or its equivalent EP 0733584), which disclose crane jibs made of several elements, that can be furled for road transport. This solution does, however, entail a heavy-duty hydraulic actuating cylinder, and reinforcements to the structure of the crane in order to bear the weight of the assembly consisting of the actuating cylinder, the link rods and the levers, and also to bear the loads introduced by the actuating cylinder when the jib is being furled or unfurled. This entails the presence of significant additional mass in the jib itself, hence limiting the functional characteristics of the crane and therefore reducing the maximum load that can be lifted.

### BRIEF SUMMARY

The disclosure seeks to solve the problem of the dismantling of delivery tower cranes, more particularly from the point of view of the furling or, conversely, the unfurling, of the jib, using a solution that is simple, economical and free of danger and which also does not substantially modify or increase the weight of the initial structure of the jib, thus maintaining the initial performance of the crane in terms of the load that can be lifted.

To this end, the subject of the invention is a delivery tower crane jib with furling device, the jib being made up of two or more jib elements with at least two consecutive jib elements joined together by a horizontal pivot pin, with which there is associated a furling device driven by at least one actuating cylinder, particularly a hydraulic actuating cylinder, this crane jib being essentially characterized in that the furling device comprises, on a first jib element, the actuating cylinder one end of which is permanently articulated to this jib element and, secured to a second jib element, a set of attachment points laid out on one and the same circle centred on the pivot pin connecting the two jib elements in question, the other end of the actuating cylinder being designed to be selectively and detachably connected to one of the attachment points so that the jib can be furled or unfurled through a succession of rotations corresponding to the angular spacing between two consecutive attachment points, means being provided for temporarily immobilizing one jib element with respect to the other in one or more intermediate furling positions, particularly when the said other end of the actuating cylinder has been detached from one attachment point so that it can be aligned with and connected to another attachment point.

In one preferred embodiment of the invention, the set of attachment points includes a series of holes formed, at regular angular spacings, at the periphery of a disc or of a plate secured to the said second jib element and centred on the pivot pin connecting the two jib elements, whereas the said other end of the actuating cylinder is designed to be connected detachably to a chosen one of the aforementioned holes by a disengageable pin.

Thus, the jib is furled by actuating the actuating cylinder the end of which is initially pinned through one hole in the disc and then by pinning the end of the actuating cylinder through the next hole and operating the actuating cylinder once again, and so on, until the moved jib element has been rotated through about 180° in total, which corresponds to the complete furling of this jib element. For example, if the holes in the disc are separated from one another by angular spacings of 60°, then three identical manoevres need to be carried out in order to achieve a total rotation of 180°, folding the second jib element horizontally onto the top of the first jib element which is kept stationary.

The means of temporary immobilization are needed to keep the jib element that is to be moved in a partially furled position for the time taken for an operator to detach the end of the actuating cylinder from one hole in the disc and pin this end through the next hole. Advantageously, the said means of temporary immobilization comprise at least one additional hole connected to the jib element that bears the actuating cylinder, this hole being able to accommodate a removable connecting or immobilizing pin which likewise can be engaged in one of the holes of the aforementioned set of holes, that can be brought in to register with the said additional hole. Thus, the immobilizing function is performed by making use of one of the holes in the disc (which at that moment is not being used for the connection between the actuating cylinder and the disc) while the additional hole may be formed in a lug or yoke of the jib element that bears the actuating cylinder, this constituting a simple, compact and economical solution.

The operations of pinning and unpinning the end of the actuating cylinder, and of fitting or removing the connecting or immobilizing pin can be performed by hand by an operator stationed at that time in the jib crab gondola, so that the human intervention required here is free of danger.

### BRIEF DESCRIPTION OF THE DRAWINGS

In any event, the invention will be better understood with the aid of the description which follows, with reference to the attached schematic drawing which, by way of example, depicts one embodiment of this delivery tower crane jib with furling device:

FIG. 1 is a side view of a crane jib according to the present invention, in the unfurled position;

FIG. 2 is a side view of the jib of FIG. 1, during furling;

FIG. 3 is a side view of the same jib during furling, in a later intermediate position;

FIG. 4 is a detailed part view of the jib of FIGS. 1 to 3, in the unfurled position, more specifically showing the region where the two jib elements are articulated to one another;

FIG. 5 shows, in even greater detail, the furling device during the operation of furling the jib;

FIG. 6 is a detail view similar to FIG. 4, but corresponding to the jib in the entirely furled position; and

FIGS. 7 and 8 illustrate the use of a tower crane with a jib according to the invention in the construction of a cooling tower.

### DETAILED DESCRIPTION

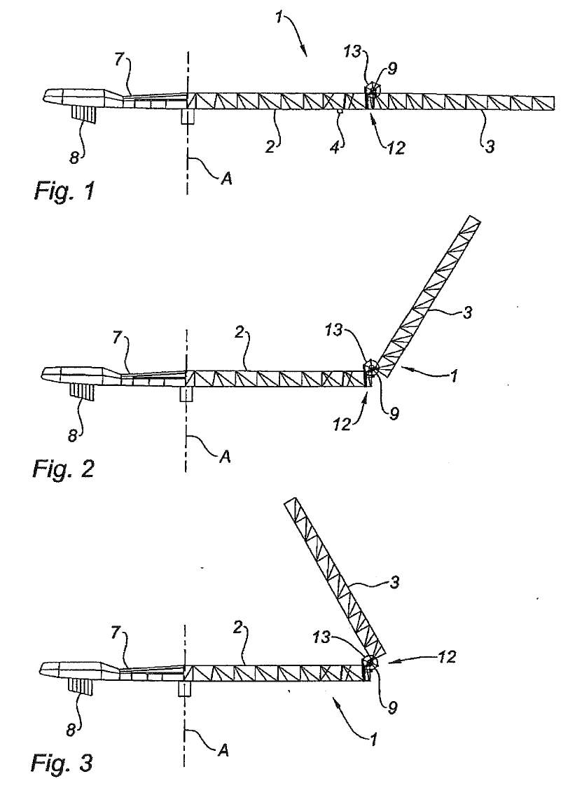

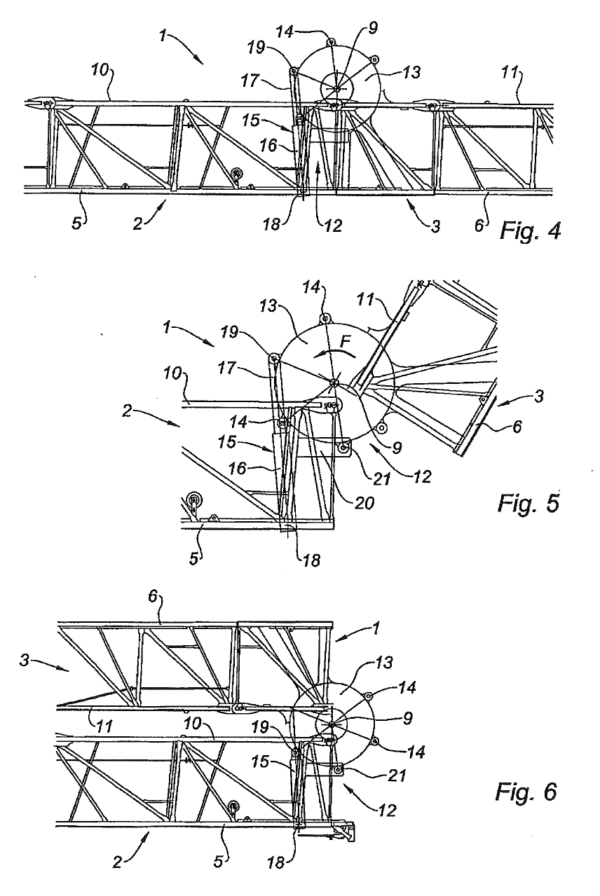

FIG. 1 depicts, in its entirety, a crane jib denoted overall by the reference 1, the jib 1 being orientable about a vertical axis A at the top of a mast (not depicted here). The jib 1 is made up of two jib elements which are a first jib element 2 situated closest to the axis A, and a second jib element 3 which extends the first jib element 2. A jib crab 4 can move along the jib 1, more particularly along a runway formed by the respective lower members 5 and 6 of the two jib elements 2 and 3 (see also FIGS. 4 to 6).

To the rear of the axis A, the jib 1 is extended by a counterjib 7 which supports a counterweight 8.

As suggested by FIGS. 2 and 3, the second jib element 3 can be folded down on top of the first jib element 2. To do this, and as shown in greater detail in FIGS. 4 and 6, the second jib element 3 is articulated to the front of the first jib element 2 about a horizontal pin 9 situated substantially level with the respective upper members 10 and 11 of the two jib elements 2 and 3, the pivot pin 9 being directed transversely with respect to the longitudinal direction of the jib 1.

Between the two jib elements 2 and 3 thus articulated there is a furling device denoted overall by the reference 12.

The furling device 12 comprises a disc 13 which is centred on the pivot pin 9 and secured to the second jib element 3. The disc 13 is pierced at its periphery with a plurality of equidistant holes 14, for example four holes 14 separated from one another by angular spacings of 60° such that these holes 14 are present over at least half of the circumference of the disc 13.

The furling device 12 also comprises a hydraulic actuating cylinder 15 arranged in a substantially vertical orientation with an actuating cylinder body 16 and an actuating cylinder rod 17. The actuating cylinder body 16 is articulated permanently, about a horizontal pin 18, to the front end of the first jib element 2, more specifically level with the lower members 5 of this jib element 2. The free upper end of the actuating cylinder rod 17 is articulated, about a horizontal pin 19, to the disc 13. The pivot pin 19 of the actuating cylinder rod 17 passes through one of the holes 14 in the disc 13, this pin 19 being disengageable so that it can be inserted selectively into any one of the holes 14 in the disc 13.

Finally, the unfurling device 12 comprises a lug or a yoke 20 borne by the front end of the first jib element 2 and directed forwards. The lug or yoke 20 is pierced with at least one hole that can be brought into register with one or other of the holes 14 in the disc 13. A removable connecting pin 21 is designed to pass through the hole in the lug or yoke 20 and the hole 14 in the disc 13 which have been brought in to register with one another.

By virtue of such an unfurling device 12, the jib 1 can be unfurled as follows, starting form the horizontal unfurled position depicted in FIGS. 1 and 4:

To start off with, the two jib elements 2 and 3 are aligned, and the end of the actuating cylinder rod 17 is connected, by the pin 19, to the second hole 14 in the disc 13 (the holes 14 being counted in the clockwise direction with respect to the drawing). The actuating cylinder rod 17 is therefore fully deployed.

Next, the actuating cylinder 15 is actuated in the direction of retracting the actuating cylinder rod 17 into the actuating cylinder body 16, which causes the disc 13 to rotate through an angle of 60° about the horizontal pin 9, in the anticlockwise direction. The rotation of the disc 13 is accompanied by a corresponding rotation of the second jib element 3, and therefore also by a rotation of this jib element 3 through 60° in the anticlockwise direction about the horizontal pin 9 (see arrow F in FIG. 5). The second jib element 3 thus reaches a partially furled position, raised to 60° with respect to the horizontal and directed forward, as shown in FIGS. 2 and 5.

In this partially furled position, the second jib element 3 is immobilized by positioning the removable connecting pin 21 in the first hole 14 in the disc 13 and in the hole in the lug or yoke 20. Once the second jib element 3 has thus been immobilized, the actuating cylinder rod 17 is detached from the disc 13 by removing the pin 19 which is disengageable, and once the rod 17 has been deployed out from the actuating cylinder body 16, the end of this rod 17 will be pinned through the next hole 14 in the disc 13, namely the third hole 14, re-fitting the pin 19.

Having removed the connecting pin 21, to free the disc 13 to rotate, the actuating cylinder 15 is made to perform a further retraction stroke of its rod 17, causing the disc 13 and the second jib element 3 to rotate through a further 60°, in order to bring this second jib element into a furled position at 120°, as depicted in FIG. 3.

The second jib element 3 is immobilized again in this position, by introducing the connecting pin 21, and the end of the actuating cylinder rod 17 is then pinned through the fourth hole 14 in the disc 3. A third manoeuvre of the actuating cylinder 15 is then performed, to cause the disc 13 and the second jib element 3 to effect a final 60° rotation. This second jib element 3 has therefore described a total rotation of 180°, such that it is folded down horizontally on top of the first jib element 2 (see FIG. 6). The crane jib 1 is thus fully furled.

Of course, reverse manoeuvres of the actuating cylinder 15, again with alternating unpinnings of the pins 19 and 21, will enable the jib 1 to be unfurled, that is to say will enable the second jib element 3 to be brought back into the direct continuation of the first jib element 2.

During these manoeuvres, the operator stations himself in a gondola of the jib crab 4, from where he can, without danger, perform the operations of pinning and unpinning the two pins 19 and 21.

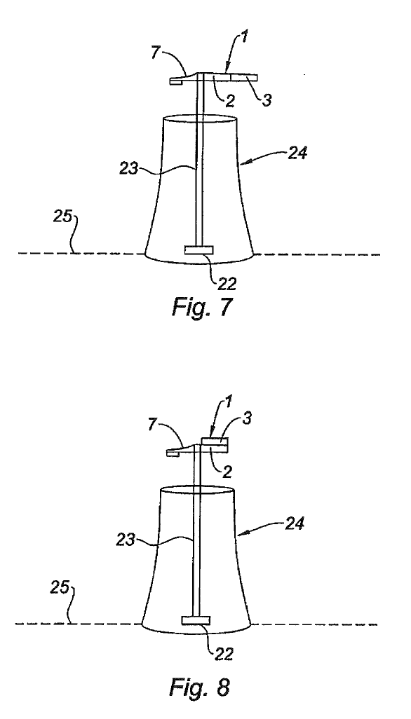

FIGS. 7 and 8 illustrate one use of a tower crane provided with a jib 1 as previously described, the crane here being depicted complete with its base chassis 22 and its mast 23 at the top of which the jib 1 is mounted. The application in question is the construction of a cooling tower 24 of a thermal or nuclear electricity power station, the mast 23 of the crane standing along the vertical axis of the cooling tower 24 under construction.

As FIG. 7 shows, when the construction of the cooling tower 24 is over, this tower 24 obstructs a dismantling of the crane simply by shortening the mast 23 accompanied by a lowering of the jib 1.

By contrast, as illustrated by FIG. 8, furling the jib 1 by folding the second jib element 3 on top of the first jib element 2, as described previously, “shortens” the jib 1 allowing it to be lowered down inside the cooling tower 24 as far as ground level 25.

As goes without saying, the invention is not restricted to the sole embodiment of this tower crane which has been described hereinabove by way of example; on the contrary, it encompasses all embodiment and application variants thereof that follow the same principle. Thus, in particular, the following would not constitute departures from the scope of the invention:
altering the number of holes at the periphery of the disc and accordingly the individual angle of rotation of this disc, for example by providing holes separated by angular spacings of 90° or 45°;
replacing the circular disc with a component of some different shape, such as a hexagonal or square plate;
positioning the actuating cylinder in a horizontal or oblique orientation rather than a vertical one;
reversing the arrangement of the furling device, that is to say by having the disc secured to the first jib element and the actuating cylinder on the side of the second jib element;
applying the invention to a crane jib made up of more than two elements articulated to one another;
using the same furling device for tower cranes used in the construction of all kinds of buildings or structures that may present a similar problem with the dismantling of the crane.

1. Delivery tower crane jib with furling device, the jib comprising:
two or more jib elements with at least two consecutive jib elements joined together by a horizontal pivot pin, with which there is associated a furling device driven by at least one actuating cylinder
wherein the furling device comprises, on a first jib element, the actuating cylinder one end of which is permanently articulated to this jib element and, secured to a second jib element, a set of attachment points laid out on one and the same circle centred on the pivot pin connecting the two jib elements in question, the other end of the actuating cylinder being designed to be selectively and detachably connected to one of the attachment points so that the jib can be furled or unfurled through a succession of rotations corresponding to an angular spacing between two consecutive attachment points, means (20, 21) being provided for temporarily immobilizing one jib element with respect to the other in one or more intermediate furling positions when the other end of the actuating cylinder has been detached from one attachment point so that it can be aligned with and connected to another attachment point.

2. Crane jib according to claim 1, wherein the set of attachment points comprises a series of holes formed, at regular angular spacings, at a periphery of a disc or of a plate secured to the second jib element and centred on the pivot pin connecting the two jib elements, whereas the said other end of the actuating cylinder is designed to be connected detachably to a chosen one of the aforementioned holes by a disengageable pin.

3. Crane jib according to claim 2, wherein the means of temporarily immobilizing one jib element with respect to the other in intermediate furling positions comprise at least one additional hole connected to the jib element that bears the actuating cylinder, the hole being able to accommodate a removable connecting or immobilizing pin which likewise can be engaged in one of the holes of the aforementioned set of holes, that can be brought in to register with the additional hole.

4. Crane jib according to claim 3, wherein the additional hole is formed in a lug or yoke of the jib element that bears the actuating cylinder.

5. Delivery tower crane comprising a jib with furling device according to any one of claim 1.

6. Delivery tower crane according to claim 5, configured to build a cooling tower of a thermal or nuclear electricity power station, a mast of the crane standing on a vertical axis of the cooling tower under construction.
